(19) United States
(12) Patent Application Publication
(10) Pub. No.: US 2025/0053035 A1
(43) Pub. Date: Feb. 13, 2025

(54) VARIABLE TRANSMISSION OPTICAL DEVICE AND ANTENNA

(71) Applicant: ALPHAMICRON INCORPORATED, Kent, OH (US)

(72) Inventors: Bahman Taheri, Shaker Heights, OH (US); Tamas Kosa, Hudson, OH (US)

(73) Assignee: ALPHAMICRON INCORPORATED, Kent, OH (US)

(21) Appl. No.: 18/927,621

(22) Filed: Oct. 25, 2024

Related U.S. Application Data
(63) Continuation-in-part of application No. 18/138,133, filed on Apr. 24, 2023.
(60) Provisional application No. 63/363,404, filed on Apr. 22, 2022.

(51) Int. Cl. G02F 1/133; G02F 1/1343

(52) U.S. Cl. CPC G02F 1/13306; G02F 1/13439

(57) ABSTRACT

An eyewear system includes a variable transmission optical device (“VTOD”), a VTOD driving system, and an antenna system. The VTOD includes a first transparent electrode over a first substrate, a second transparent electrode over a second substrate, and an electro-optic material comprising a liquid crystal provided between the substrates. Each transparent electrode is interposed between its respective substrate and the electro-optic material. The VTOD driving system is in electrical communication with the first and second transparent electrodes and configured to apply a first voltage profile across the transparent electrodes for controlling an amount of light transmitted through the VTOD. The antenna system includes at least one antenna electrode and at least one component electrode and is configured to apply or sense a second voltage profile to transmit or receive wireless signals. At least one transparent electrode acts as the antenna electrode or as the component electrode.

### CROSS-REFERENCE TO RELATED APPLICATIONS

This application is a Continuation-in-Part of U.S. patent application Ser. No. 18/138,133 entitled VARIABLE TRANSMISSION OPTICAL DEVICE AND ANTENNA, filed on Apr. 24, 2023, which claims priority to, and any other benefit of, U.S. Provisional Patent Application Ser. No. 63/363,404 entitled VARIABLE TRANSMISSION OPTICAL DEVICE AND ANTENNA, filed Apr. 22, 2022, the entire disclosures of which are fully incorporated herein by reference.

### TECHNICAL FIELD

The present disclosure relates to systems, for example eyewear systems, that include a variable transmission optical device and an antenna for sending or receiving wireless data.

### BACKGROUND

Eyewear systems have begun to incorporate various electronic capabilities. Various eyewear systems are known that include the ability to take photos, record videos, play audio, act as a phone headset, or display additional information in a person's visual field of view (augmented reality or AR) or the like. Eyewear capable of one or more of such functions are sometimes referred to as “smart glasses”. In many cases, smart glasses use a wireless transmitter/receiver to communicate with other devices, e.g., to download or upload data to a cell phone. Eyewear systems are also known that include electronically controlled lenses that adjust the brightness of light reaching a person's eyes, which may sometimes be referred to as light adaptive eyewear or electronic sunglasses.

It would be advantageous to combine the function of smart glasses with that of light adaptive eyewear. However, such multifaceted functionality generally calls for multiple, often dedicated, components that can add weight, bulk, and complexity to the device. In some cases, this may make the eyewear system uncomfortable or unattractive. Further, there is the risk that one component may interfere with the function of another component. Thus, there is a desire to provide smart glasses with light adaptive functionality without significant sacrifice of comfort, style, or functionality.

### SUMMARY

In accordance with an embodiment, an eyewear system includes a variable transmission optical device (“VTOD”), a VTOD driving system, and an antenna system. The VTOD includes a first transparent electrode provided over a first substrate, a second transparent electrode provided over a second substrate, and an electro-optic material comprising a liquid crystal provided between the substrates, wherein each transparent electrode is interposed between its respective substrate and the electro-optic material. The VTOD driving system is in electrical communication with the first and second transparent electrodes. The VTOD driving system is configured to apply a first voltage profile across the transparent electrodes for controlling an amount of light transmitted through the VTOD. The antenna system includes at least one antenna electrode and at least one component electrode. The antenna system configured to apply or sense a second voltage profile to transmit or receive wireless signals. At least one transparent electrode serves as the at least one antenna electrode or as the at least one component electrode.

The eyewear systems described herein allow efficient use of the available area of the VTOD to support antenna system features. In some cases, the systems herein leverage the VTOD transparent electrodes to also serve as an electrode of the antenna system. In these ways, antenna functionality can be added to the eyewear system with reduced need for additional space-taking antenna elements that prior art systems require. In some cases, the system may allow the first and second voltage profiles to be applied concurrently which simplifies the electronics relative to a case where operational time is split between the optical device and the antenna system.

### BRIEF DESCRIPTION OF DRAWINGS

FIG. 1 is a schematic cross-section of a non-limiting example of a VTOD according to some embodiments.

FIG. 2 is a perspective view of a non-limiting example of an eyewear system according to some embodiments.

FIG. 3A is a perspective view of a non-limiting example of an eyewear system according to some embodiments.

FIG. 3B is a perspective view of a non-limiting example of an eyewear system according to some embodiments.

FIG. 4A shows a top view of a non-limiting example of a transparent conductor patterned over a VTOD substrate according to some embodiments.

FIG. 4B is a cross-sectional from FIG. 4A along cutline B-B.

FIG. 4C is a cross-sectional view of a non-limiting example of a VTOD according to some embodiments.

FIG. 4D shows a top view of a non-limiting example of a transparent conductor patterned over a VTOD substrate according to some embodiments.

FIG. 4E shows a top view of another non-limiting example of a transparent conductor patterned over a VTOD substrate according to some embodiments.

FIG. 4F is a cross-sectional view of the structure from FIG. 4E along cutline F-F.

FIG. 4G is a cross-sectional view of another non-limiting example of VTOD according to some embodiments.

FIG. 5 is a diagram illustrating a non-limiting example of an electronic driving subsystem and VTOD according to some embodiments.

FIG. 6 is a non-limiting example of a VTOD cell time response curve according to some embodiments.

FIG. 7A is a diagram of a VTOD voltage profile at first transparent electrode according to some embodiments.

FIG. 7B is a diagram of the same VTOD voltage profile from FIG. 7A, but also carrying a wireless voltage profile (combined voltage profile) according to some embodiments.

FIGS. 8A-8D are non-limiting schematic views of various eyewear systems according to some embodiments.

FIGS. 9A and 9B are non-limiting schematic views of various other eyewear systems according to some embodiments.

### DETAILED DESCRIPTION

### General VTOD

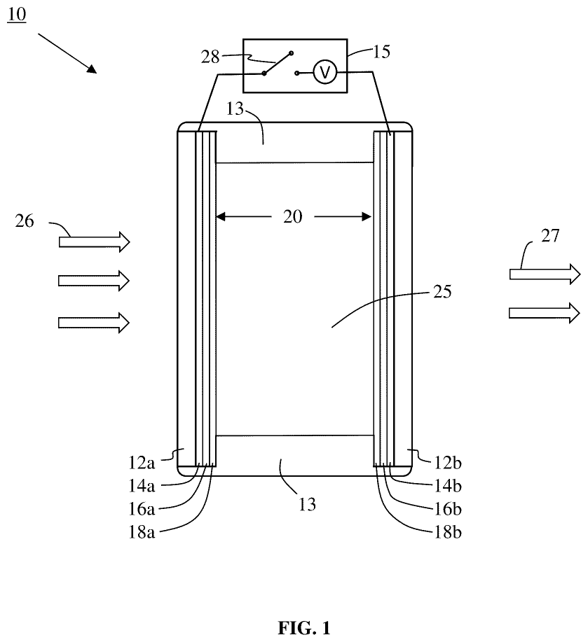

Adaptive eyewear may include one or more variable transmission optical devices (“VTODs”), for example as part of an eyewear system lens element. FIG. 1 is a schematic cross-section of a non-limiting example of a VTOD according to some embodiments. VTOD 10 can controllably act on incident light 26 so that transmitted light 27 has been modulated or altered in some way (brightness, hue, polarization, direction, or the like). VTOD 10 may include a pair of VTOD substrates, 12a, 12b, which may be independently selected and include, for example, a polymeric material, a glass, or a ceramic. VTOD 10 may include a pair of transparent electrically conducting layers, 14a, 14b, which may be provided or coated over each respective substrate surface interior to the cell. The transparent conducting layers may be referred to as first transparent electrode 14a and second transparent electrode 14b. In some embodiments, an optional passivation layer (which in some cases may be referred to as an insulating layer or “hard coat”), 16a, 16b, may be provided over the respective transparent conducting layer. The passivation layer may include, for example, a non-conductive oxide, sol-gel, polymer, or a composite. An optional alignment layer 18a, 18b, may be provided over the passivation layer or the transparent conducting layer. As a non-limiting example, the alignment layer may include polyimide. In some embodiments, the alignment layer may function as a passivation layer. In some embodiments, the alignment layer may be brushed as is known in the art to assist in orienting the electro-optic material, e.g., a liquid crystal “LC” materials, near the surface. In some embodiments, both alignment layers of a cell are brushed. In some embodiments, a cell may include only one brushed alignment layer.

In some embodiments, VTOD 10 includes electro-optic material 25, e.g., a liquid crystal material such as a guest-host mixture or the like, provided between the cell's pair of substrates 12a, 12b. The electro-optic material is capable of changing from a state of higher light transmittance to a state of lower light transmittance in a desired wavelength region of light upon a change in an electric field applied across the electro-optical material. The electric field may be changed, for example, by changing the voltage applied between the VTOD's pair of transparent electrodes 14a, 14b. The substrates and any overlying layers define a cell gap 20. To aid in maintaining the separation, optional spacers (not shown), such as glass or plastic rods or beads, may be inserted between the substrates. The cell gap (normally about 3 to 50 μm, preferably 4-12 μm). The VTOD cell may be enclosed by sealing material 13 such as a UV-cured optical adhesive or other sealants known in the art. In some embodiments, the sealing material may cover a portion of the transparent conducting layers at the substrate edge to contain the electro-optic material.

The transparent electrodes 14a, 14b, may be electrically connected to a controller 15. Controller 15 may include one or more variable voltage supplies which are represented schematically by the encircled V. FIG. 1 shows the VTOD power circuit with its switch 28 open so that no voltage is applied. When switch 28 is closed, a variable voltage or electric field may be applied across liquid crystal guest-host mixture 25. In some embodiments, the voltage applied between the transparent conductive layers may be constant for a period of time with respect to polarity or amplitude. In some embodiments, the voltage profile may change or alternate at some frequency where, for a period of time, the polarity applied at first transparent electrode 14a is positive and the polarity applied at transparent electrode 14b is negative, and for another period of time, the polarities are reversed where the polarity applied at conductive layer 14a is negative and the polarity applied at conductive layer 14b is positive. This alternating polarity may take on any type of wave form (sinusoidal, square, triangular, sawtooth, or the like) and may generally have a frequency of less than 500 Hz. In some embodiments, the voltage applied between the electrodes may be in a range of 0 to 30 V. In some embodiments, an eyewear system may include a lens element having two or more stacked VTODs as disclosed in PCT Application No. PCT/US22/44310, Titled “MULTI-COLOR VARIABLE TRANSMISSION OPTICAL DEVICE (Soto et al.), the entire contents of which are incorporated herein by reference for all purposes. In some embodiments, an eyewear system may include passive optical features such as lenses, polarizers, photochromic dyes, or the like, that do not generally respond to electronic control.

Note that the designation of “first” substrate and “second” substrate herein is entirely arbitrary. Although incident light 26 is shown impinging the first substrate, it could instead be incident on the second substrate and exit the first substrate as transmitted light 27.

### Electro-Optic Material

An electro-optic material is one capable of changing its light absorption profile upon application of an electric field. Electro-optical systems include electrochromic and liquid crystal (LC) systems. In some embodiments, the electro-optic material includes a guest-host system having an LC host and a dichroic (DC) dye provided therein, e.g., dissolved or dispersed therein, or alternatively as a dichroic light absorbing moiety covalently bonded to the LC host, or even a combination thereof.

A guest-host effect is an electro-optical effect that involves a mixture of dichroic dye “guest” and liquid crystal “host” wherein the dichroism is adjusted within a voltage-controllable liquid crystal cell. In an isotropic host, the molecules are randomly oriented, and the effective absorption is a weighted average: α_{eff}=(2α⊥+α∥)/3. In an anisotropic LC host material, designed for polarization independent operation, the absorption can be increased to α_{eff}=(α⊥+α∥)/2 or decreased (e.g. to α⊥), depending on the desired effect.

In some embodiments, a liquid crystal guest-host includes a mixture of a cholesteric liquid crystal host and a dyestuff material. The dyestuff material may be characterized as having dichroic properties, and as described below, may include a single dye or a mixture of dyes to provide these properties. In some embodiments, the liquid crystal guest-host mixture may be formulated as a “narrow band mixture” (e.g., resulting in a spectral absorption band width having a Full Width at Half Max (FWHM) that is less than or equal to 175 nm) or as a “wide band mixture” (e.g., resulting in spectral absorption band width that is greater than 175 nm).

### LC Host

In general, the LC host may have a negative dielectric anisotropy (“negative LC”) or a positive dielectric anisotropy (“positive LC”). In some embodiments, the host includes a chiral nematic or cholesteric liquid crystal material (collectively “CLC”). The CLC can also be positive or negative, depending on the application. In some embodiments of the CLC, the liquid crystal material is cholesteric, or it includes a nematic liquid crystal in combination with a chiral dopant. A CLC material has a twisted or helical structure. The periodicity of the twist is referred to as its “pitch”. The orientation or order of the liquid crystal host may be changed upon application of an electric field, and in combination with the dyestuff material, may be used to control or partially control the optical properties of the cell. In some embodiments, the CLC may be further characterized by its chirality, i.e., right-handed chirality or left-handed chirality.

A wide variety of LC, including CLC, materials are available and have potential utility in various embodiments of the present disclosure.

### Dyestuff Material

To provide dichroic properties, the dyestuff material generally includes at least one dichroic (DC) dye or mixture of DC dyes. In some cases, the dyestuff material may optionally further include a photochromic (PC) dye or a photochromic-dichroic (PCDC) dye whose light absorbance may be activated by exposure to UV light such as sunlight. In some embodiments, the dyestuff material may further include a small amount of a conventional absorbing dye, e.g., to provide the device with a desired overall hue in the clear state.

### DC Dyes

Dichroic (DC) dyes typically have an elongated molecular shape and exhibit anisotropy in its light absorption properties parallel (α_{∥}) and perpendicular (α_{⊥}) to the molecule, this being characterized by the dichroic ratio, DR=α_{∥}/α_{⊥}. Any molecule having a dichroic ratio (DR) that deviates from unity is one that exhibits “dichroism”. Commonly, the absorption is higher along the long axis of the molecule and such dyes may be referred to as “positive dyes” or dyes exhibiting positive dichroism. Positive DC dyes are generally used herein. However, in some cases, negative DC dyes that exhibit negative dichroism may be used instead. In some embodiments, a DC dye (as measured in a LC host) may have a dichroic ratio of at least 5.0, alternatively at least 6, 7, 8, 9, 10, 11, 12, 13, 14, 15, 16, 17, 18, 19 or 20.

The level of visible light absorption by the DC dye may be a function of the dye type and the LC host. The apparent absorption of visible light may also be a function of voltage. The orientation or long-range order of the LC may be a function of electric field or voltage across the cell thickness. A DC dye exhibits some alignment with the LC host so that application of a voltage may be used to alter the apparent darkness (absorbance) or transparency (opaque-ness) of the cell.

In some embodiments, a DC dye may include a small molecule type of material. In some embodiments, a DC dye may include an oligomeric or polymeric material. The chemical moiety responsible for light absorption may, for example, be a pendant group on a main chain. Multiple DC dyes may optionally be used, for example, to tune the light absorption envelope or to improve overall cell performance with respect to lifetime or some other property. DC dyes may include functional groups that may improve solubility, miscibility with or bonding to the LC host. Some non-limiting examples of DC dyes may include azo dyes, for example, azo dyes having 2 to 10 azo groups, or alternatively, 2 to 6 azo groups. Other DC dyes are known in the art, such as anthraquinone and perylene dyes. Generally, molecule with dichroic properties are know, such as for example those described in “Dyes as guests in ordered systems: current understanding and future directions” By Mark T. Sims (Pages 2363-2374) in Liquid Crystals, Volume 43, 2016—Issue 13-15.

### Other VTOD Cell Features

### Substrate

Referring again to FIG. 1, in some embodiments, the VTOD substrate 12a, 12b may be independently selected and may include a plastic, a glass, a ceramic, or some other material. Choice of material and its particular properties depends in part on the intended application. For many applications, the substrate should be at least partially transmissive to visible light. In some embodiments a substrate may have higher than 45% transmission to visible radiation having a wavelength between 400 nm and 700 nm, alternatively, higher than 50%, 60%, 70%, 80%, 90%, or 95% transmission. In some embodiments, the substrate may have high optical clarity (low haze) so that a person may clearly see through the VTOD. In some embodiments, the support may optionally have some color or tint. In some embodiments, the substrate may have an optical coating on the outside of the cell. A substrate may be flexible or rigid.

As some non-limiting examples, a plastic substrate may include a polycarbonate (PC), a polycarbonate and copolymer blend, a polyethersulfone (PES), a polyethylene terephthalate (PET), cellulose triacetate (TAC), a polyamide, p-nitrophenylbutyrate (PNB), a polyetheretherketone (PEEK), a polyethylenenapthalate (PEN), a polyetherimide (PEI), polyarylate (PAR), a polyvinyl acetate, a cyclic olefin polymer (COP) or other similar plastics known in the art. In some non-limiting examples, flexible glass including materials such as Corning® Willow® Glass and the like can be used as a substrate. A substrate may include multiple materials or have a multi-layer structure.

In some embodiments, the thickness of a substrate may be in a range of 25 μm to 500 μm. Preferred range includes 50 μm-200 μm.

### Transparent Conducting Layer

“Visible light” generally refers to a wavelength range of about 400 nm to about 700 nm. By “transparent” conducting layer, it is meant that the conducting layer allows an overall transmittance of at least 45% of incident visible light. A transparent conducting layer may absorb or reflect a portion of visible light and still be useful. In some embodiments, the transparent conducting layer may include a transparent conducting oxide (TCO) including, but not limited to, ITO or AZO. In some embodiments, the transparent conducting layer may include a conductive polymer including, but not limited to, PEDOT:PSS, a poly(pyrrole), a polyaniline, a polyphenylene, or a poly(acetylene). In some embodiments, the transparent conducting layer may include a partially transparent thin layer of metal or metal nanowires, e.g., formed of silver, copper, aluminum, or gold. In some embodiments, the transparent conducting layer may include graphene.

### Eyewear System

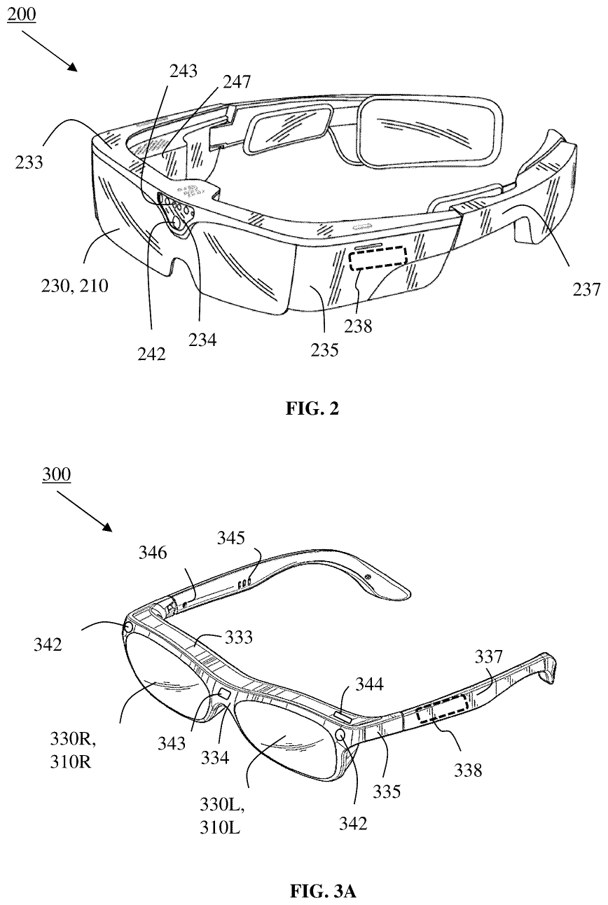

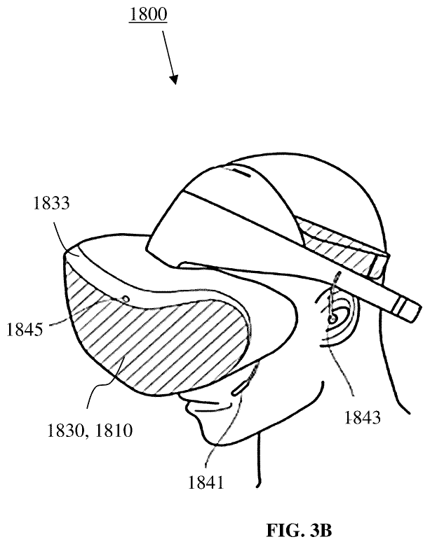

FIGS. 2 and 3A are perspective views of some non-limiting examples of eyewear systems according to some embodiments. In some cases, as shown in FIG. 2, an eyewear system 200 may include a single lens element 230 extending across both eyes of a person. The lens element may include a VTOD 210. In some embodiments, as shown in FIG. 3A, an eyewear system 300 may include separate lens elements 330L and 330R. One or both lens elements may include a VTOD, e.g., VTOD 310L and/or VTOD 310R. The structure and materials of the VTODs may be the same or different, and the operation of the VTODs may be commonly controlled in full or in part, or individually controlled in full or in part. In some cases, a VTOD (e.g., 210, 310L, 310R) may be combined with, or laminated to, another optical element or carrier such as a prescription or non-prescription lens to form the respective lens element. Note that the VTOD may be positioned such that the first substrate is further from the user's eyes than the second substrate, or alternatively, such that the second substrate is further from the user's eyes than the first substrate.

The optical elements or VTODs may be attached to an eyewear system frame, which can have many shapes. An eyewear system frame may include a primary frame (which may in some cases may be referred to as a “rim”) 233, 333 to which the VTOD may be attached. An eyewear system frame may optionally further include a bridge region 234, 334, end pieces 235, 335 attached to (or forming part of) the primary frame or rim, and/or temples 237, 337 extending from the end pieces which may have ends or tips that fit behind a person's ears. In some cases, a VTOD may be attached to a frame component in addition to, or other than, the primary frame, e.g., to an end piece or temple. In some embodiments, a VTOD may act as a side eye shield, for example, where the VTOD extends partly along one or both temples. Various frames and eyewear system shapes can be used, such as a VR system 1800 as shown in FIG. 3B which includes primary frame 1833, lens element 1830 and VTOD 1810. The VR system may include other electronic devices such as a microphone 1841, an earpiece 1843, a light sensor 1845, or numerous other devices.

In some embodiments, the eyewear system is a smart eyewear system having various electronic components besides the VTOD. For example, the eyewear system may include one or more cameras 242, 342, sensors 243, 343, speakers 345, microphones 346, operational switches 344, display projection devices 247 for augmented reality, or some other useful electronic component. The locations of the various electronic devices are not limited to the locations shown in the figures. The eyewear system may include onboard electronics or controllers for operating such electronic devices. In some cases, onboard electronics 238, 338 may be embedded within the eyewear system. The onboard electronics may be separate from or integrated with the controller(s) that operate the VTODs. The eyewear system may further include one or more batteries (optionally rechargeable) or a power cable leading to a separate battery pack. The temple, end piece, or frame may include touch-sensitive features, e.g., surface or projected capacitive technology, that allows touch control via finger taps, sweeps or the like. In some cases, the eyewear system may include components (hardware, software, and/or firmware) that allow operation by voice command.

The eyewear system may include wireless electronics for transmitting and/or receiving wireless signals, e.g., via a transceiver or the like. In some embodiments, the eyewear system may be in wireless communication with a cell phone or other electronic device. For example, the cell phone may include one or more apps that control the eyewear system in some way (e.g., play music, operate microphones/speakers for phone calls, display images via AR, or the like). In some cases, the cell phone may receive data from the eyewear system, e.g., videos, images, voice recordings, GPS location history, or the like. In some cases, such apps may also enable operational communication between the VTOD and the cell phone (or other device).

In some cases, the wireless signals for communication between the eyewear system and another device may use WIFI frequencies, e.g., those above about 800 MHZ and may extend as high as about 70 GHz. In some embodiments, the WIFI communication may utilize Bluetooth technology and frequencies.

Effective wireless communication generally requires one or more antennae. For conventional smart glasses, these are typically built into or onto the frame by adding wires. For example, a wire may be provided in the rim around each lens, across the bridge, or along the temples. In some cases, an antenna system may be used including multiple antennas in various locations and orientations that may widen the directional area to/from which it effectively sends/receives signals.

In embodiments of the present disclosure, the antenna or antenna system may be simplified by leveraging components of the VTOD, in particular one or both transparent electrodes.

### Patterned Transparent Conductor

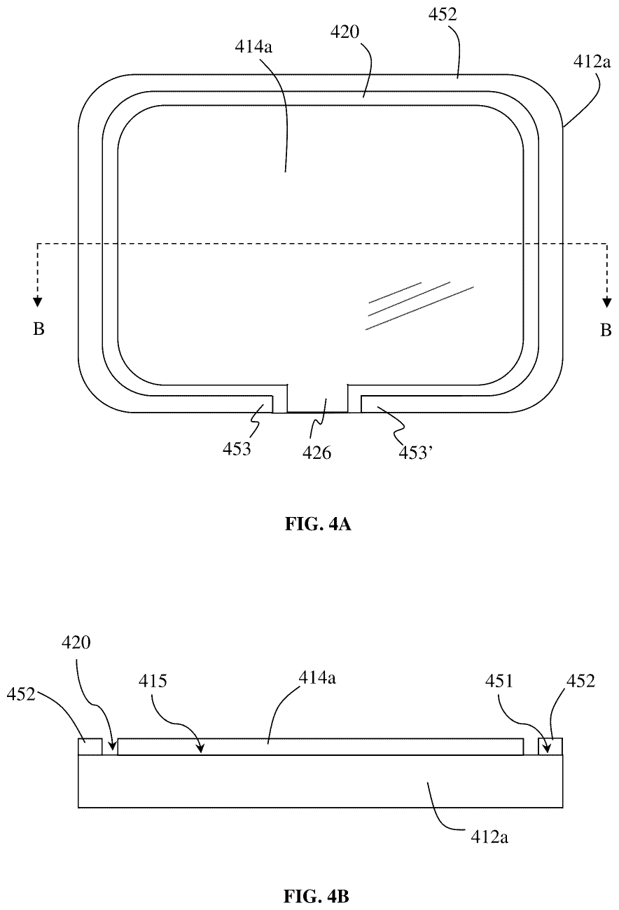

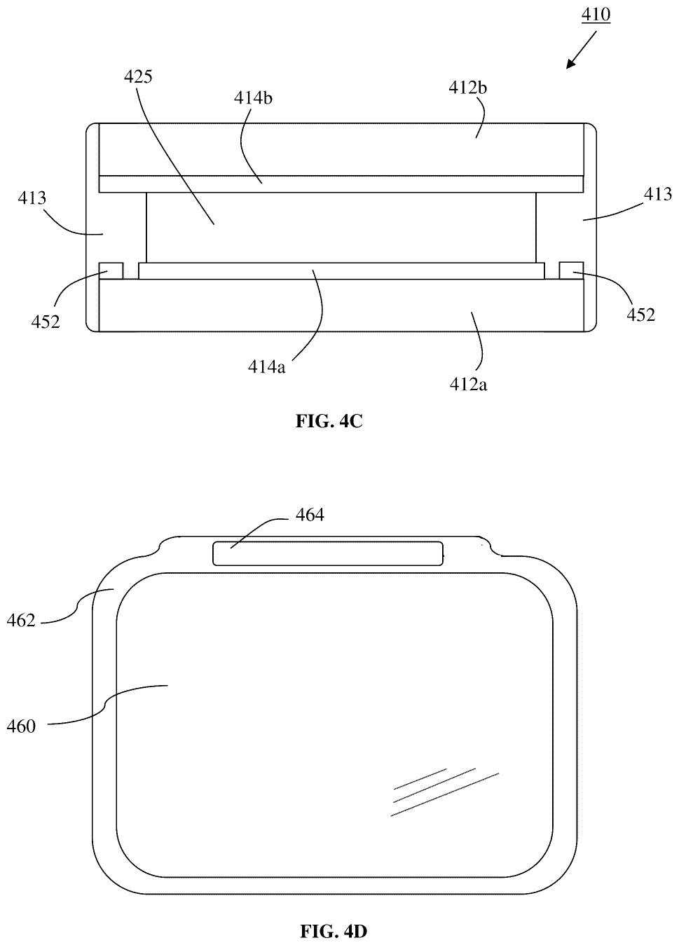

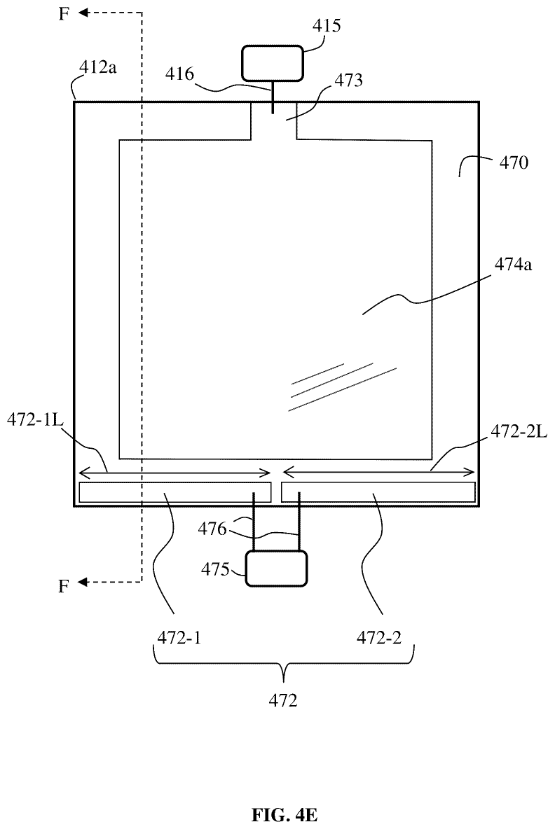

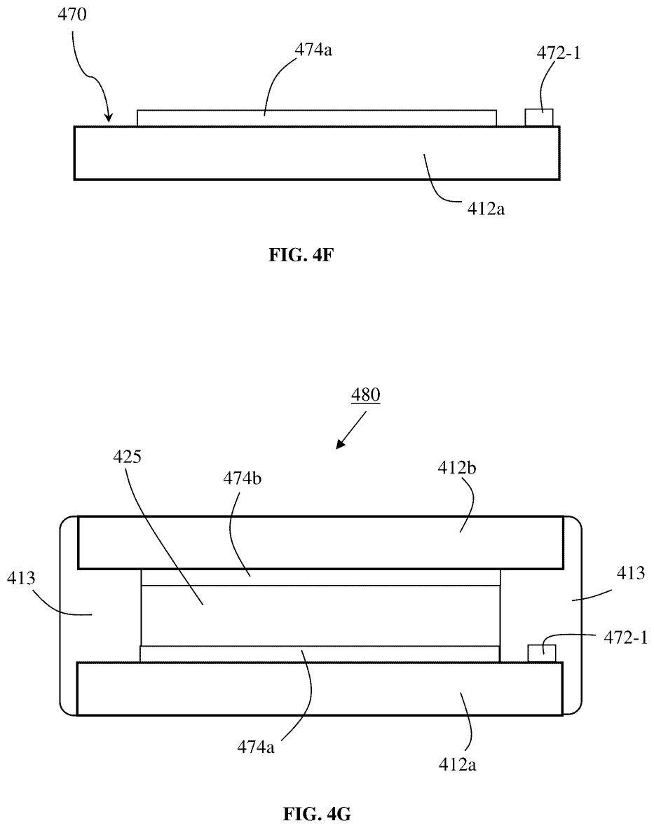

In some embodiments, one or both transparent conductive layers of a VTOD may be patterned so that a portion of it may be used as an antenna electrode instead of as a VTOD electrode. For example, FIG. 4A shows a top view of a non-limiting example of a transparent conductor patterned over a VTOD substrate according to some embodiments. The shape may in some cases correspond to a desired lens element for an eyewear system. FIG. 4B is a cross-sectional from FIG. 4A along cutline B-B. In some embodiments a transparent conductive layer may be applied across first VTOD substrate 412a and then patterned by conventional lithographic methods to etch away a portion thereby forming a first transparent electrode 414a provided over a first electrode area 415 of the substrate, and an antenna electrode 452 provided over an antenna area 451 of the first substrate and electrically isolated from the first transparent electrode 414a. In some embodiments, the patterning may form a first transparent electrode contact region 426 for connecting the first transparent electrode to driving circuitry for the VTOD. Contact to the antenna electrode for connecting to antenna circuitry (e.g., a receiver, transmitter, a transceiver) may be anywhere along the antenna, but may optionally be at antenna electrode contact area 453 or 453′ or both. The antenna electrode may in some embodiments act as a loop antenna, but other designs may be used to make, for example, a dipole antenna, a monopole antenna, a virtual dipole antenna, a quadrupole antenna, a hybrid of two or more of these, or some other antenna type. In some embodiments, first VTOD substrate 412a (having the antenna electrode) may represent the substrate and electrode furthest from a user's eye(s).

Many methods can be used for forming the first transparent electrode 414a and antenna electrode 452. In some embodiments, rather than etch-patterning a transparent conductor by lithography, the first transparent electrode 414a and antenna electrode 452 may be formed by printing an etchant or a conductivity-damaging agent in the desired isolation (non-conductive) region 420 between these features. In some embodiments, the first transparent electrode and antenna electrode may be formed directly by pattern printing using a transparent conductive ink, such printing including but not limited to, ink jet, flexographic, gravure, or contact printing. In some embodiments, the material of the first transparent electrode may be the same as the material of the antenna electrode. In some embodiments, the material of the first transparent electrode may be different from the material of the antenna electrode. As illustrated in FIG. 4B, in some embodiments, the antenna electrode 452 and the first transparent electrode 414a may lie in a common plane parallel to a plane defined by the surface of the first VTOD substrate 412a.

FIG. 4C is a cross-sectional view of a non-limiting example of a VTOD according to some embodiments. VTOD 410 may include a pair of VTOD substrates, first VTOD substrate 412a, and second VTOD substrate 412b, which may be independently selected as previously described. VTOD 410 may include a pair of transparent electrically conducting layers, first transparent electrode 414a, and second transparent electrode 414b, which may be provided or coated over each respective substrate surface interior to the cell. An antenna electrode 452 may also be formed on the first VTOD substrate in electrical isolation from the first transparent electrode 414a, e.g., as described with respect to FIGS. 4A and 4B. That is, the first transparent electrode may be provided over a first electrode area of the first substrate, and the antenna electrode may be provided over an antenna area of the first substrate. Similarly, the second transparent electrode may be provided over a second electrode area of the second substrate. In the embodiment shown in FIG. 4C, the second electrode area occupies substantially the entire surface of the second substrate, but other designs may be used. VTOD 410 includes electro-optic material 425 between the transparent electrodes. The VTOD cell may be enclosed by scaling material 413 such as a UV-cured optical adhesive or other sealants known in the art. VTOD 410 may generally have any of the properties, materials, layer structure, or cell architectures described previously with respect to FIG. 1.

In some embodiments, the sealing material 413 may optionally cover a portion of the transparent conducting layers at the edge. In some embodiments, a sealing material may cover at least a portion of the antenna electrode. Such a design makes efficient use of the available substrate area for both scaling and the antenna electrode. That is, the edge area is often wasted space with respect to VTOD functionality due to the need for sealants and the like, but such space is no longer wasted in the present embodiment since it now includes an antenna electrode. The design further ensures that the antenna electrode does not inadvertently act on the electro-optic material or interfere with the VTOD operation. Although not shown in FIG. 4C, the second transparent electrode may optionally be patterned, e.g., to provide for another antenna electrode on the second VTOD substrate. Alternatively, the positions of the first and second transparent electrodes may be switched so that the antenna is on the second substrate. In some embodiments, both substrates can have an antenna electrode used for different purposes.

FIG. 4D shows a top view of another non-limiting example of a transparent conductor patterned over a VTOD substrate according to some embodiments. The shape may in some cases correspond to a desired lens element for an eyewear system. First transparent electrode 460 is separated from antenna electrode 464 by the isolation (non-conductive) region 462. Antenna electrode 464 may in some cases be a monopole antenna electrode or a virtual dipole antenna. The isolation region 462 may correspond to the surface of a VTOD substrate or a portion of a conductive layer that has been rendered non-conductive. In this embodiment, the antenna electrode does not extend around the entire periphery of the cell but only occupies a portion of the periphery. In some examples, this portion may be positioned where the VTOD connects to the primary frame of the eyewear system. Note that some other embodiments, antenna electrode 464 may have some other shape, for example, the antenna electrode may extend along most of one side, two sides, three sides, or around the entire periphery of the VTOD substrate.

FIG. 4E shows a top view of another non-limiting example of a transparent conductor patterned over a first substrate 412a according to some embodiments. The first transparent electrode 474a is separated from dipole antenna 472 by isolation (non-conductive) region 470. In this embodiment, the dipole antenna 472 has two dipole antenna electrodes, 472-1 and 472-2, each characterized by a dipole antenna electrode length 472-1L and 472-2L, respectively. In some cases, each dipole antenna electrode length, or alternatively their combined lengths, as measured along the first substrate may be about λ4, λ/2, λ(⅝), or some other useful length, where λ is the wavelength of the wireless signal to be received or transmitted. The dipole antenna electrodes are each connected to an antenna microcontroller 475 by wiring 476. The dipole antenna and microcontroller are part of an antenna system that is configured to apply or sense a voltage profile to transmit or receive wireless signals. The first transparent electrode may be connected to a VTOD microcontroller 415 by wiring 416 provided at a connection area 473. Although not illustrated here, a second transparent electrode would also be connected to VTOD microcontroller for providing a VTOD driving voltage profile as described elsewhere herein. In some embodiments, the controller 415 and antenna system 475 may be separate and each have their own operational microcontroller. In other embodiments, controller 415 and antenna system 475 may be fully or partially integrated into a common microcontroller system. As described elsewhere herein, one or both dipole antenna electrodes may in some cases be formed of the same conductive material as the first transparent electrode. Alternatively, the dipole antenna electrodes may include a different conductive material and may be less transparent or even opaque relative to the transparent electrode material with respect to visible light.

FIG. 4F is a cross-sectional view of the structure from FIG. 4E along cutline F-F. FIG. 4G is a cross-sectional view of another non-limiting example of VTOD according to some embodiments. VTOD 480 may include the first substrate and other components shown in FIGS. 4E and 4F. VTOD 480 may include a pair of VTOD substrates, first VTOD substrate 412a, and second VTOD substrate 412b, which may be independently selected as previously described. VTOD 480 may include a pair of transparent electrically conducting layers, first transparent electrode 474a, and second transparent electrode 474b, which may be provided or coated over each respective substrate surface interior to the cell. VTOD 480 may include an antenna electrode, such as a dipole antenna 472. For example, FIG. 4G shows one of the dipole antenna electrodes, 472-1, formed on the first VTOD substrate in electrical isolation from the first transparent electrode 474a, e.g., as described with respect to FIGS. 4E and 4F. That is, the first transparent electrode may be provided over a first electrode area of the first substrate, and the antenna electrode may be provided over an antenna area of the first substrate. Similarly, the second transparent electrode may be provided over a second electrode area of the second substrate. In the embodiment shown in FIG. 4G, the second transparent electrode occupies a similar area as the first transparent electrode such that the antenna electrode is not substantially covered by the second transparent electrode in a direction orthogonal to the plane of the first substrate. That is, the second transparent electrode is not oppositely positioned relative to the antenna electrode. By “not substantially covered”, it is meant that less than 25% of the antenna electrode area is covered by (oppositely positioned relative to) the second transparent electrode, alternatively, less than 15%, 10%, 5%, or 1%. Depending on the design and wireless signals, having the antenna not blocked by the second electrode may help reception and transmission. However, in other cases, the second transparent electrode may extend over a larger area of the second substrate, even over the antenna.

VTOD 480 includes electro-optic material 425 between the transparent electrodes. The VTOD cell may be enclosed by sealing material 413 such as a UV-cured optical adhesive or other sealants known in the art. VTOD 410 may generally have any of the properties, materials, layer structure, or cell architectures described previously with respect to FIG. 1.

In some embodiments, the scaling material 413 may optionally cover a portion of the transparent conducting layers at the edge. In some embodiments, a sealing material may cover at least a portion of the antenna electrode (e.g., at least 50% of the antenna electrode area, alternatively, at least 75%, 90%, 95% of the antenna electrode area), or alternatively, substantially all of the antenna electrode (e.g., at least 99%). Such a design makes efficient use of the available substrate area for both sealing and the antenna electrode. That is, the edge area is often wasted space with respect to VTOD functionality due to the need for sealants and the like, but such space is no longer wasted in the present embodiment since it now includes an antenna electrode. The design may further ensure that the dipole antenna electrode does not inadvertently act on the electro-optic material or interfere with the VTOD operation. Although not shown in FIG. 4G, the second transparent electrode may optionally be patterned, e.g., to provide for another antenna electrode on the second VTOD substrate. In some embodiments. both substrates can have an antenna electrode used for different purposes. In some cases, the first substrate may have one dipole antenna electrode and the second substrate may have the second dipole antenna electrode.

### Common Transparent Electrode/Antenna Electrode

In some embodiments, there is no need for two conductive areas separated by an isolation area. Rather, one or both transparent electrodes of the VTOD may also act as an antenna electrode for wireless communication. For example, the VTOD may look similar to that shown in FIG. 1 but with modified electronics to allow transmission or reception of wireless signals. In particular, the eyewear system may include an electronic driving subsystem that operates both the VTOD function and the antenna function.

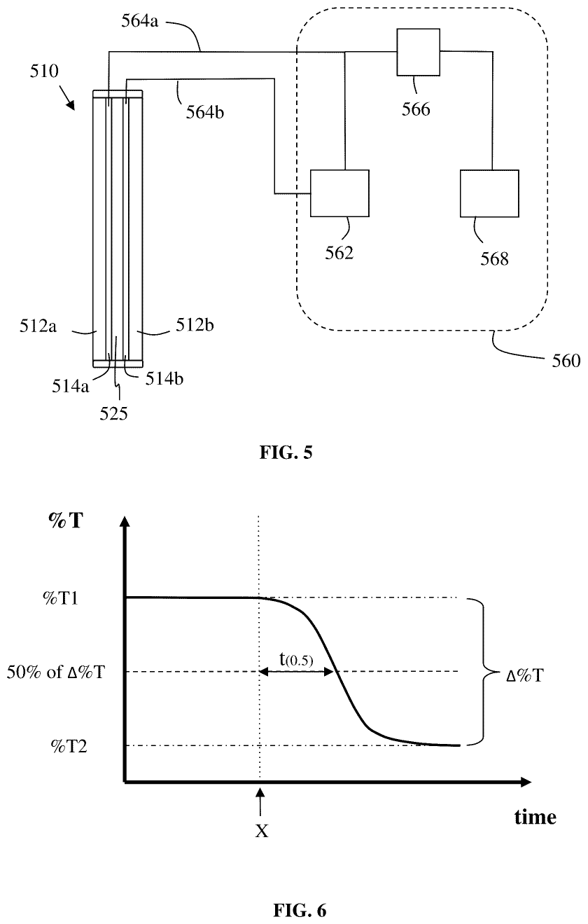

FIG. 5 is a diagram illustrating a non-limiting example of an electronic driving subsystem and VTOD according to some embodiments. For clarity, only a few features of the VTOD are shown in FIG. 5, but the VTOD properties, materials, layer structure and cell structure may be as previously described. VTOD 510 may include a first substrate 512a, a first transparent electrode 514a disposed over a surface of the first substrate interior to the VTOD cell, a second substrate 512b, a second transparent electrode 514b disposed a surface of the second substrate interior to the VTOD cell, and electro-optic material 525 disposed between the two transparent electrodes. The transparent electrodes may be in electrical communication with electronic driving subsystem 560. In some embodiments, the electronic driving subsystem 560 may include a controller 562, a signal modifier 566, and a receiver 568. The first transparent electrode 514a may also serve as an antenna for wireless communications and is connected to the electronic driving subsystem via lead 564a. The second transparent electrode may be connected to the electronic driving subsystem via lead 564b.

Controller 562 may include circuitry for applying the desired VTOD and/or wireless driving signal. A VTOD driving signal is an electric signal that is applied to the transparent electrodes that has various characteristics including voltage (amplitude, polarity), frequency, duration, and waveform (sine wave, square wave, triangle wave, sawtooth wave, alternating polarity, non-alternating polarity, or the like). These characteristics may be referred to as the VTOD voltage profile. Each of these characteristics may influence the LC's molecular movement and orientation, which in turn results in a change of the VTOD's optical response. In some cases, a VTOD may be designed so that the time response of the LC cell to an applied voltage is visually fast, that is, it may change state from a dark (absorptive) or opaque (scattering) state to a more transparent (transmissive) state (or vice versa) almost instantaneously to an observer, or in less than 0.25 sec. Even when imperceptible to an observer, the molecular reorientation across the cell takes some time, which is a function of the LC host material, the LC-dye mixture, temperature, voltage, cell gap and other factors.

FIG. 6 is a non-limiting example of a VTOD cell time response curve according to some embodiments. At a first voltage V1, a VTOD may have a first optical transmission, % T1. When a second voltage V2 is applied that is sufficient to induce molecular reorientation, the VTOD may have a second optical transmission, % T2, that is less than % T1. The change may be referred to as 4% T. As shown in FIG. 6, this transition over time may not always be linear. There are many ways to measure a response time. One metric is t_{(0.5)}, which is the time it takes for the 9% T to change 50% of 4% T from time X when the voltage is switched from V1 to V2. In some embodiments, VTOD 510 may have a t_{(0.5)} that is not less than 0.1 milliseconds, alternatively not less than 0.5, 1, 2, 5, 10, 20, 50, 100 or 200 milliseconds. Although there is a wide variety of useful VTOD voltage profiles, in general, a VTOD frequency component is generally less than 1 kHz, alternatively less than 500 Hz, 250 Hz, 150 Hz, 100 Hz, 80 Hz, 60 Hz, 50 Hz, or 40 Hz. In some cases, the frequency component may be at least 30 Hz, e.g., to avoid possible perceived flicker by a user. In some embodiments the VTOD voltage profile has no frequency component (0 Hz) or is DC voltage. In some embodiments, the VTOD voltage profile may include alternating positive and negative polarities. In some embodiments, the alternating polarities occur periodically (e.g., at a frequency in a range of about 30 to 250 Hz, alternatively about 60 to 150 Hz) or at select times.

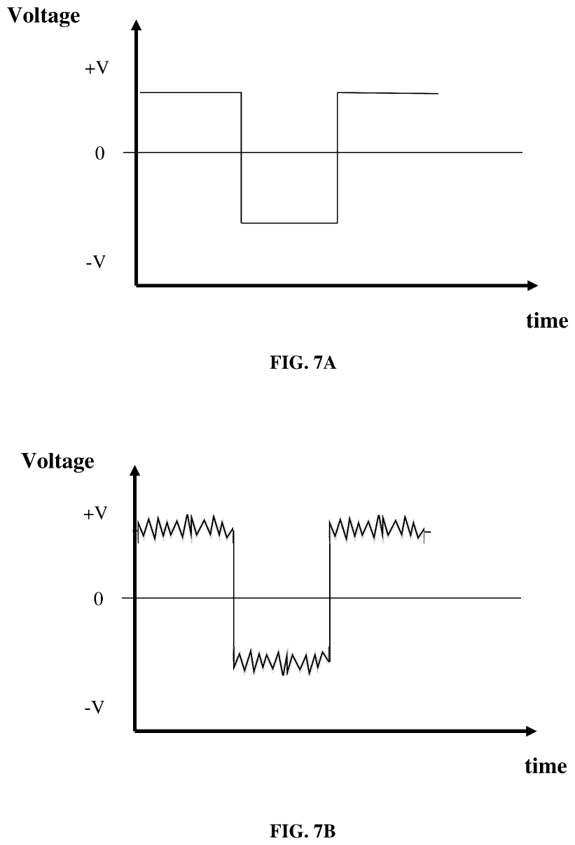

In some embodiments, the first transparent electrode 514a (FIG. 5) may also act as an antenna electrode for transmitting wireless data when an antenna/wireless voltage is applied. For example, controller 562 may add an RF signal characterized by a wireless voltage profile in addition to or on top of the VTOD voltage profile applied at the first transparent electrode via lead 564a. In some cases, the antenna or wireless voltage profile may have a frequency of at least 200 MHz, alternatively, at least 400 MHZ, 600 MHZ, 800 MHZ, 1 GHZ, 2 GHZ, 5 GHZ, 10 GHz, 20 GHz, or 50 GHz. The wireless voltage profile may use standard wireless communications frequencies, e.g., as defined by IEEE 802.11. These wireless voltage profile frequencies are too fast to cause any significant effect on the VTOD response, thus allowing the VTOD first transparent electrode to also act as a transmitter antenna electrode. FIG. 7A is a diagram of a VTOD voltage profile at first transparent electrode 514a and FIG. 7B is a diagram of the same VTOD voltage profile also carrying a wireless voltage profile (combined voltage profile). FIGS. 7A and 7B are simply illustrative and the actual wave forms, amplitudes, and frequencies may take on many alternative appearances. Rather than controller 562, a separate RF/wireless signal generating component could be placed in communication with lead 564a to apply the wireless voltage waveform component.

In some embodiments, the first transparent electrode 514a may act as an antenna for receiving wireless data. For example, a controller 562 may apply a VTOD voltage profile such as shown in FIG. 7A. The first transparent electrode 514a may also be in range of another device transmitting wireless signals. These wireless signals cause fluctuations in the voltage profile at the transparent electrode reflective of the frequency of the transmitted signals. That is, the received wireless signals may superimpose a wireless voltage profile onto the VTOD voltage profile such as shown in FIG. 7B. Referring again to FIG. 5, in some embodiments, a signal modifier component 566 may be electronic communication with the first transparent electrode 514a. In some cases, a signal modifier may include a bandpass or other frequency filter that isolates the wireless voltage profile signal. In some embodiments, a signal modifier may be in communication with controller 562 and subtract the applied VTOD voltage to isolate the wireless voltage profile signal. The isolated signal may be fed to receiver 568 for conversion to computer-readable data. The electronic driving subsystem may include additional features or functionality, e.g., amplifiers, modulators, electronic filters, or the like. The electronic driving subsystem may further be in electronic communication with one or more additional antennas optionally provided with other electronic components or elsewhere on the eyewear system.

In some embodiments, the first transparent electrode 514a may act as one pole of an antenna and the second transparent electrode 514b may act as another pole of an antenna. In some cases, first transparent electrode 514a may act as a monopole antenna electrode and the second transparent electrode 514b may act as a reference electrode such as a ground electrode. As a system, the first and second transparent electrodes may function as a virtual dipole antenna. Although not illustrated, an edge area of the first transparent electrode may be in contact with a metal layer, e.g., extending along one side or more sides of the transparent electrode (optionally under an edge seal). Such a metal layer may be made, for example, by deposition from a metallic ink onto an edge portion of the transparent electrode. The metal layer may in some cases enhance the antenna functionality of the first transparent electrode, e.g., as a monopole antenna electrode or as one pole of a dipole antenna electrode. The second transparent electrode may also include a metal layer, e.g., to act as the other pole of a dipole antenna.

In some embodiments, an eyewear system may include a VTOD, a VTOD driving system, and an antenna system that includes at least one antenna electrode and at least one component electrode, such that at least one of the transparent electrodes of the VTOD also serves as an antenna electrode or as a component electrode.

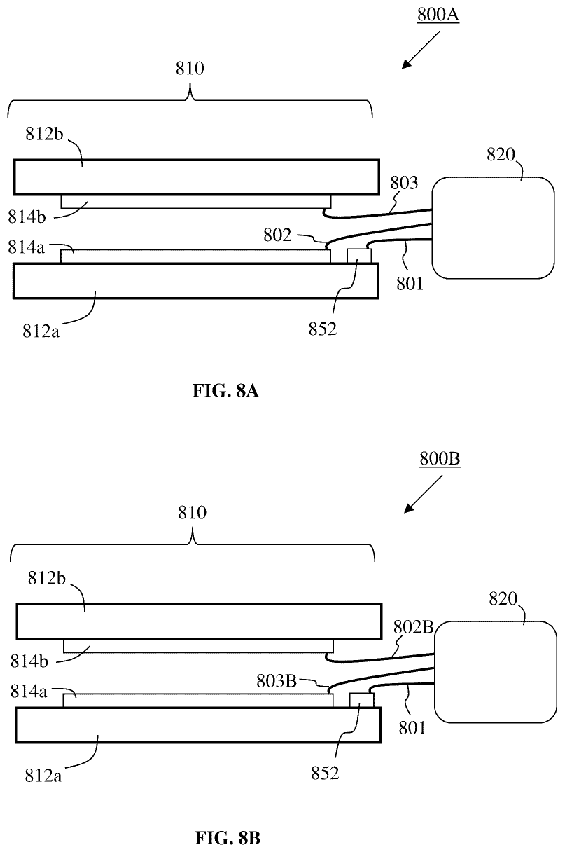

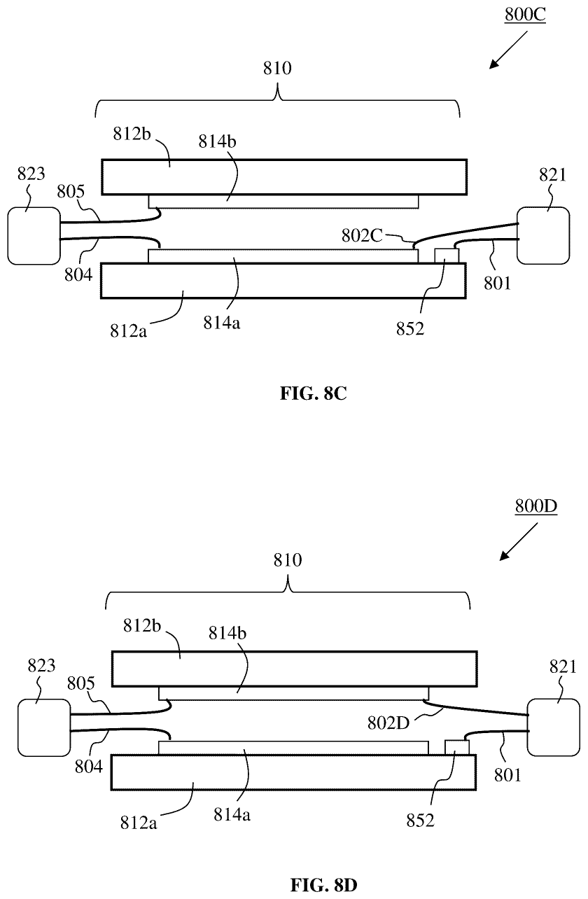

FIGS. 8A-8D are non-limiting schematic views of various eyewear systems according to some embodiments. Eyewear systems 800A-800D may include VTOD 810, a VTOD driving system, and an antenna system having at least one antenna electrode 852 and at least one component electrode. At least one of the transparent electrodes of the VTOD, in addition to its VTOD function, also serves as a component electrode which functions in cooperation with the antenna electrode to allow the antenna system to serve, for example, as a monopole antenna, a dipole antenna, a virtual dipole antenna, a quadrupole antenna, or some other type of antenna. In some cases, the component electrode may act as a ground electrode, a reference electrode, an antenna trace, or as another pole of the antenna system (e.g., where the antenna electrode 852 is one pole and the component electrode is another pole). The component electrode may alternatively be referred to as a secondary electrode. As a specific non-limiting example, the component electrode may act as a ground or mirror to antenna electrode 852 (which may have a monopole configuration) to produce a virtual dipole antenna.

For clarity, only a few of the VTOD 810 components are shown in FIGS. 8A-8D, including first and second substrates 812a and 812b, and first and second transparent conductors 814a and 814b. Antenna electrode 852 is provided on the first substrate and is separate from the first transparent conductor 814a. Although not illustrated in this schematic, VTOD 810 includes a liquid crystal electro-optic material disposed between the transparent electrodes, and may further include other components as described elsewhere herein, including but not limited to, a scaling material and/or others described with respect to FIG. 1. Given its location, antenna electrode 852 may also be referred to herein as a first substrate antenna electrode 852, and which may be prepared by any method described elsewhere herein. The shape, length, conductive material, and other properties of antenna electrode 852 may be selected to suit the intended function of the antenna system. In some cases, the antenna electrode may have a length as measured along the first substrate of about λ/4, λ/2, λ(⅝), or some other useful length, where A is the wavelength of the wireless signal to be received or transmitted.

Referring to FIG. 8A, eyewear system 800A includes a common microcontroller 820 which at least in part controls i) the operation of the VTOD (i.e., the common microcontroller functions as part of the VTOD driving system), and ii) operation of the antenna system. For operating the VTOD, wiring 802 connects microcontroller 820 to the first transparent electrode 814a, and wiring 803 connects microcontroller 820 to the second transparent electrode 814b. As described elsewhere herein, a first voltage profile (which may also be referred to as a VTOD voltage profile) may be applied between the first and second transparent electrodes by microcontroller 820 via wiring 802 and 803. For operating the antenna system, wiring 801 connects microcontroller 820 to antenna electrode 852, and wiring 802 connects microcontroller 820 to the component electrode, which in this case is first transparent electrode 814a. As described elsewhere herein, a second voltage profile (which may also be referred to herein as a wireless voltage profile) may be applied between the antenna electrode and the component electrode by microcontroller 820 via wiring 801 and 802.

In some embodiments, the first and second voltage profiles may be similar to those described with respect to FIGS. 6, 7A, and 7B. Although there is a wide variety of useful first (VTOD) voltage profiles, in general, a VTOD frequency component is generally less than 1 kHz, alternatively less than 500 Hz, 250 Hz, 150 Hz, 100 Hz, 80 Hz, 60 Hz, 50 Hz, or 40 Hz. In some cases, the frequency component may be at least 30 Hz, e.g., to avoid possible perceived flicker by a user. In some embodiments the VTOD voltage profile has no frequency component (0 Hz) or is DC voltage. In some embodiments, the VTOD voltage profile may include alternating positive and negative polarities. In some embodiments, the alternating polarities occur periodically (e.g., at a frequency in a range of about 30 to 250 Hz, alternatively about 60 to 150 Hz) or at select times.

In some cases, the second (wireless) voltage profile may have a frequency of at least 200 MHz, alternatively, at least 400 MHZ, 600 MHz, 800 MHZ, 1 GHZ, 2 GHZ, 5 GHZ, 10 GHZ, 20 GHz, or 50 GHz. The wireless voltage profile may use standard wireless communications frequencies, e.g., as defined by IEEE 802.11. These wireless voltage profile frequencies are too fast to cause any significant effect on the VTOD response, thus allowing the VTOD transparent electrode to also act as a component electrode or even as an antenna electrode. Thus, the second voltage profile may be applied or sensed concurrently with application of the first voltage profile.

Referring to FIG. 8B, eyewear system 800B is similar to 800A, except that wirings 802 and 803 are reversed such that the second transparent electrode 814b acts as the component electrode of the antenna system. That is, wiring 803B connects microcontroller 820 to the first transparent electrode 814a, and wiring 802B connects microcontroller 820 to the second transparent electrode 814b. A first voltage profile may be applied between the first and second transparent electrodes by microcontroller 820 via wiring 802B and 803B. For operating the antenna system, wiring 801 connects microcontroller 820 to antenna electrode 852, and wiring 802B connects microcontroller 820 to the component electrode, which in this case is the second transparent electrode 814b. A second voltage profile may be applied between the antenna electrode and the component electrode by microcontroller 820 via wiring 801 and 802B.

Referring to FIG. 8C, eyewear system 800C is similar to 800A, but rather than a common microcontroller, the operational function of the VTOD is controlled by VTOD microcontroller 823 (part of the VTOD driving system), which is separate from antenna microcontroller 821 that controls the operational function of the antenna system. For operating the VTOD, wiring 804 connects microcontroller 823 to the first transparent electrode 814a, and wiring 805 connects microcontroller 823 to the second transparent electrode 814b. A first voltage profile may be applied between the first and second transparent electrodes by microcontroller 823 via wiring 804 and 805. For operating the antenna system, wiring 801 connects microcontroller 821 to antenna electrode 852, and wiring 802C connects microcontroller 821 to the component electrode, which in this case is first transparent electrode 814a. A second voltage profile may be applied between the antenna electrode and the component electrode by microcontroller 821 via wiring 801 and 802C. Although shown at opposite ends, the microcontrollers 821 and 823 may be similarly located. Although shown as different in FIG. 8C, the contact locations of wiring 804 and wiring 802C on the first transparent electrode may instead be the same (i.e., shared).

Referring to FIG. 8D, eyewear system 800D is similar to 800C, except that, instead of connecting to the first transparent electrode, wiring 802D is instead connected to the second transparent electrode 814b, such that the second transparent electrode serves as the component electrode of the antenna system. That is, for operating the antenna system, wiring 801 connects microcontroller 821 to antenna electrode 852, and wiring 802D connects microcontroller 821 to the component electrode, which in this case is second transparent electrode 814b. A second voltage profile may be applied between the antenna electrode and the component electrode by microcontroller 821 via wiring 801 and 802D.

The materials and methods of making antenna electrode 852 may be as described elsewhere herein with respect antenna electrodes. For example, the antenna electrode may be formed in the same plane as the first transparent electrode. The conductive material of the antenna electrode may be the same as that of the first transparent electrode or it may be different. For example, the antenna electrode may include a metal layer (optionally opaque) to improve antenna performance. The antenna electrode in some cases may be covered by the scaling material partially or entirely.

In the embodiments shown in FIGS. 8A-8D, the second transparent electrode occupies a similar area as the first transparent electrode such that the antenna electrode is not substantially covered by the second transparent electrode in a direction orthogonal to the plane of the first substrate. That is, the second transparent electrode is not oppositely positioned relative to the antenna electrode. In some cases, less than 25% of the antenna electrode area is covered by (oppositely positioned relative to) the second transparent electrode, alternatively, less than 15%, 10%, 5%, or 1%. Depending on the design and wireless signals, having the antenna not blocked by the second transparent electrode may help reception and transmission. However, in other cases, the second transparent electrode may extend over a larger area of the second substrate, even over the antenna so that it is oppositely positioned.

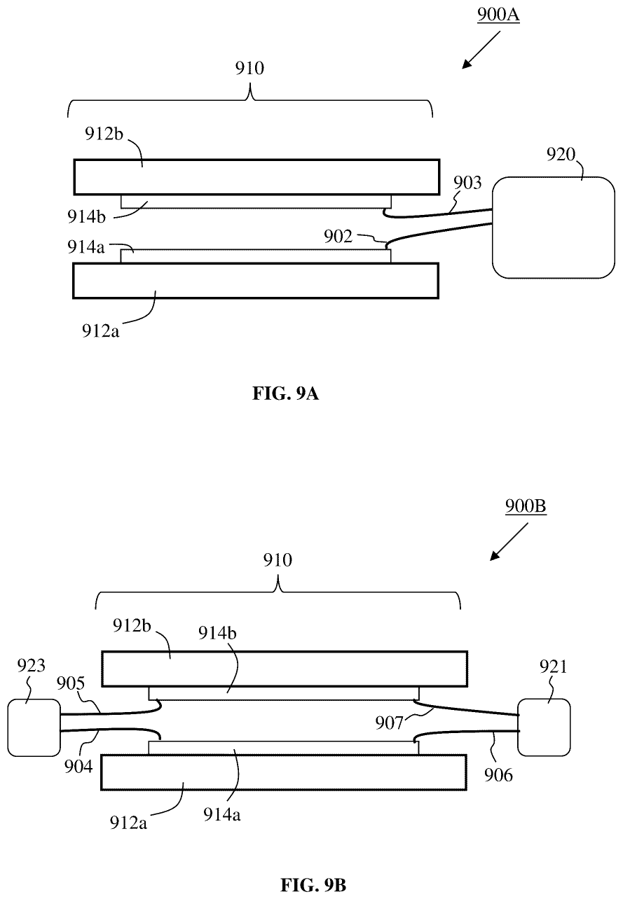

FIGS. 9A and 9B are non-limiting schematic views of various other eyewear systems according to some embodiments. Eyewear systems 900A and 900B include a VTOD, a VTOD driving system and an antenna system that utilizes one or both of the VTOD transparent electrodes. Unlike eyewear systems 800A-800D, the VTOD 910 of eyewear systems 900A and 900B do not include a discrete antenna electrode on the substrate that is separate from the transparent electrode. For clarity, only a few of the VTOD 910 components are shown in FIGS. 9A-9B, including first and second substrates 912a and 912b, first and second transparent conductors 914a and 914b. Although not illustrated in this schematic, VTOD 910 includes a liquid crystal electro-optic material, and may further include other components as described elsewhere herein, including but not limited to, those described with respect to FIG. 1.

Referring to FIG. 9A, eyewear system 900A includes a common microcontroller 920 which at least in part controls i) the operation of the VTOD (i.e., the common microcontroller functions as part of the VTOD driving system), and ii) the operation of the antenna system. For operating the VTOD, wiring 902 connects microcontroller 920 to the first transparent electrode 914a, and wiring 903 connects microcontroller 920 to the second transparent electrode 914b. As described above, a first voltage profile (which may also be referred to as a VTOD voltage profile) may be applied between the first and second transparent electrodes by microcontroller 920 via wiring 902 and 903. For operating the antenna system, the same wiring is used such that a second voltage profile (which may also be referred to herein as a wireless voltage profile) may be applied between the first and second transparent electrodes by microcontroller 920 via wiring 902 and 903. As explained elsewhere, the second voltage profile may be applied or sensed concurrently with application of the first voltage profile.

In some cases, the first transparent electrode may act as an antenna electrode and the second transparent electrode may act as a component electrode, but the reverse may be true, or they may both operate as antenna electrodes. Functionally, the first and second transparent electrodes operate in conjunction with the second voltage profile to serve as an antenna system to act, for example, as a monopole antenna, a dipole antenna, a virtual dipole antenna, a quadrupole antenna, or some other type of antenna.

Referring to FIG. 9B, eyewear system 900B is similar to 900A, but rather than a common microcontroller, the operational function of the VTOD is controlled by VTOD microcontroller 923 (part of the VTOD driving system) which is separate from the antenna microcontroller 921 which controls the operational function of the antenna system. For operating the VTOD, wiring 904 connects microcontroller 923 to the first transparent electrode 914a, and wiring 905 connects microcontroller 923 to the second transparent electrode 914b. A first voltage profile may be applied between the first and second transparent electrodes by microcontroller 923 via wiring 904 and 905. For operating the antenna system, wiring 906 connects microcontroller 921 to the first transparent electrode 914a, and wiring 907 connects microcontroller 921 to the second transparent electrode 914b. A second voltage profile may be applied between the first and second transparent electrodes by microcontroller 921 via wiring 906 and 907. Although shown at opposite ends, the microcontrollers 921 and 923 may be similarly located. The contact locations of wiring 904 and wiring 906 to the first transparent electrode may be different (as shown) or the same (i.e., shared), and similarly, the contact location so wiring 905 and 907 on the second transparent electrode may be different (as shown) or the same (i.e., shared).

In the embodiments shown in FIGS. 9A-9B, the second transparent electrode occupies a similar area as the first transparent electrode, and the two are positionally aligned in a direction orthogonal to the plane of the first substrate. In some other embodiments, one transparent electrode may be larger (occupy a larger area) than the other transparent electrode. Alternatively, one transparent electrode may be offset from the other so that an edge portion of one or both transparent electrodes is not oppositely positioned relative to the other transparent electrode.

Although not illustrated, an edge area of the first and/or second transparent electrode may be in contact with a metal layer, e.g., extending along one side or more sides of the respective transparent electrode (optionally under an edge seal). Such a metal layer may be made, for example, by deposition from a metallic ink. The metal layer may in some cases enhance the antenna functionality of the transparent electrode.

Still further embodiments herein include the following enumerated embodiments.

1. An eyewear system comprising:
a) a variable transmission optical device (“VTOD”) comprising:
i) a first transparent electrode provided over a first transparent electrode area of a first substrate;
ii) a second transparent electrode provided over a second transparent electrode area of a second substrate; and
iii) an electro-optic material provided between the substrates, wherein each transparent electrode is interposed between its respective substrate and the electro-optic material; and
b) an antenna electrode provided over an antenna area of the first substrate, wherein the antenna electrode is electrically isolated from the first transparent electrode.

2. The eyewear system of embodiment 1, wherein the antenna electrode is not in contact with the electro-optic material.

3. The eyewear system of embodiment 1 or 2, wherein the VTOD further comprises a sealing material to contain said electro-optic material, and wherein the sealing material covers at least a portion of the antenna electrode.

4. The eyewear system according to any of embodiments 1-3, wherein the antenna electrode acts as a loop antenna.

5. The eyewear system according to any of embodiments 1-3, wherein the antenna electrode acts as a monopole, dipole, or virtual dipole antenna.

6. The eyewear system according to any of embodiments 1-5, further comprising an eyewear system frame to which the VTOD is attached.

7. The eyewear system of embodiment 6, further comprising one or more electronic components provided on or in the eyewear system frame, wherein said electronic components comprises a camera, a sensor, a speaker, a microphone, a switch, a display projection device, or any combination thereof.

8. The eyewear system of claim 6 or 7, further comprising a second antenna electrode provided on the eyewear system frame.

9. The eyewear system of embodiment 8, wherein the antenna electrode acts as a loop antenna and the second antenna electrode acts as a monopole, dipole or virtual dipole antenna.

10. The eyewear system according to any of embodiments 1-9, further comprising wireless electronics for transmitting or receiving wireless signals wherein the antenna electrode is in electronic communication with the wireless electronics.

11. The eyewear system according to any of embodiments 1-10, wherein the first transparent electrode comprises a transparent conducting oxide, a conductive polymer, graphene, metal nanowires, or a thin layer of metal.

12. The eyewear system according to any of embodiments 1-11, wherein the antenna electrode comprises a transparent conducting oxide, a conductive polymer, graphene, metal nanowires, or a thin layer of metal.

13. The eyewear system according to any of embodiments 1-12, wherein the first transparent electrode and the antenna electrode comprise substantially the same conductive material.

14. The eyewear system according to any of embodiments 1-13, wherein the first transparent electrode and the antenna electrode lie in a common plane parallel to a plane defined by a surface of the first substrate.

15. An eyewear system comprising:
a) a variable transmission optical device (“VTOD”) comprising:
i) a first transparent electrode provided over a first substrate;
ii) a second transparent electrode provided over a second substrate; and
iii) an electro-optic material provided between the substrates, wherein each transparent electrode is interposed between its respective substrate and the electro-optic material; and
b) an electronic driving subsystem in electrical communication with the first and second transparent electrodes, the driving subsystem configured to:
i) apply a first voltage profile across the transparent electrodes for controlling an amount of light transmitted through the VTOD; and
ii) apply or sense a second voltage profile to cause one or both of the transparent electrodes to transmit or receive wireless signals.

16. The eyewear system of embodiment 15, wherein the first voltage profile has a frequency of 1 kHz or less.

17. The eyewear system of embodiment 15 or 16, wherein the second voltage profile has a frequency of greater than or equal to 200 MHz.

18. The eyewear system according to any of embodiments 15-17, wherein the first voltage profile has a frequency in a range of about 30 to about 200 Hz.

19. The eyewear system according to any of embodiments 15-18, wherein the second voltage profile has a frequency of at least 1 GHz.

20. The eyewear system according to any of embodiments 15-19, wherein the electronic driving subsystem applies or senses the second voltage profile concurrently with application of the first voltage profile.

21. The eyewear system according to any of embodiments 15-20, wherein the second voltage profile is operative to send or receive wireless signals.

22. The eyewear system according to any of embodiments 15-21, wherein at least one transparent electrode functions as an antenna for sending or receiving wireless signals.

23. The eyewear system according any of embodiments 15-22, wherein the electronic driving subsystem comprises i) a controller in electrical communication with the first and second transparent electrodes, ii) a signal modifier component in electrical communication with the controller, and iii) a receiver in electrical communication with the signal modifier.

24. The eyewear system of embodiment 23, wherein the signal modifier component comprises a bandpass filter.

25. The eyewear system of embodiment 23 or 24, wherein the receiver converts electric signals received from the signal modifier into computer-readable data.

26. The eyewear system according to any of embodiments 15-25, further comprising an eyewear system frame to which the VTOD is attached, wherein at least a portion of the electronic driving subsystem is provided as part of the eyewear system frame.

27. The eyewear system according to any of embodiments 15-26, wherein the electro-optic material comprises a liquid crystal.

28. A method of operating an eyewear system comprising a VTOD having first and second transparent electrodes and an electro-optic material disposed therebetween, the method comprising:
applying a first voltage profile across the transparent electrodes for controlling an amount of light transmitted through the VTOD; and
applying or sensing a second voltage profile on one or both transparent electrodes for transmitting or receiving wireless signals.

29. The method of embodiment 28, wherein the first voltage profile has a frequency of 1 kHz or less.

30. The method of embodiment 28 or 29, wherein the second voltage profile has a frequency of greater than or equal to 200 MHz.

31. The method according to any of embodiments 28-30, wherein the first voltage profile has a frequency in a range of about 30 to about 200 Hz.

32. The method according to any of embodiments 28-31, wherein the second voltage profile has a frequency of at least 1 GHz.

33. The method according to any of embodiments 28-32, further comprising applying or sensing the second voltage profile concurrently with applying of the first voltage profile.

34. The method according to any of embodiments 28-33, wherein the electro-optic material comprises a liquid crystal.

35. A method of making an eyewear system, the method comprising:
patterning a first transparent electrode and an antenna electrode over a first substrate, wherein the antenna electrode is electrically isolated from the first transparent electrode; and
assembling a VTOD, the VTOD comprising the first transparent electrode provided over a first transparent electrode area of the first substrate, a second transparent electrode provided over a second transparent electrode area of a second substrate, and an electro-optic material provided between the substrates, wherein each transparent electrode is interposed between its respective substrate and the electro-optic material.

36. The method of embodiment 35, wherein the antenna electrode is not in contact with the electro-optic material.

37. The method of embodiment 35 or 36, further comprising sealing the VTOD with a sealing material thereby containing the electro-optic material, wherein the sealing material covers at least a portion of the antenna electrode.

38. The method according to any of embodiments 35-37, wherein the patterning comprises etching or deactivating a layer of conductive material provided on the first substrate to form the first transparent conductor and antenna electrode.

39. The method according to any of embodiments 35-37, wherein the pattern comprises printing the first transparent conductor from a transparent conductor ink and printing the antenna from an antenna ink.

40. The method of embodiment 39, wherein at least one printing step comprises flexographic printing, gravure printing, or inkjet printing.

41. The method of embodiment 39 or 40, wherein the transparent conductor ink is the same as the antenna ink.

42. The method of embodiment 41, wherein printing the first transparent conductor and printing the antenna electrode are performed in a common printing step.

43. The eyewear system according any of embodiments 1-13, wherein the antenna electrode is a dipole antenna including two dipole antenna electrodes.

44. An eyewear system including:
a) a variable transmission optical device (“VTOD”) having:
   a first transparent electrode provided over a first substrate;
   a second transparent electrode provided over a second substrate; and
   an electro-optic material including a liquid crystal provided between the substrates, wherein each transparent electrode is interposed between its respective substrate and the electro-optic material;
b) a VTOD driving system in electrical communication with the first and second transparent electrodes, the VTOD driving system configured to apply a first voltage profile across the transparent electrodes for controlling an amount of light transmitted through the VTOD; and
c) an antenna system including at least one antenna electrode and at least one component electrode, the antenna system configured to apply or sense a second voltage profile to transmit or receive wireless signals,
wherein at least one transparent electrode serves as the at least one antenna electrode or as the at least one component electrode.

45. The eyewear system of embodiment 44, wherein the at least one antenna electrode is a first substrate antenna electrode provided on the first substrate adjacent to, and separate from, the first transparent electrode.

46. The eyewear system of embodiment 45, wherein the first transparent electrode serves as the at least one component electrode.

47. The eyewear system of embodiment 45, wherein the second transparent electrode serves as the at least one component electrode.

48. The eyewear system according to any of embodiments 45-47, wherein the second transparent electrode is not oppositely positioned relative to the first substrate antenna electrode in a dimension normal to the first substrate surface.

49. The eyewear system according to any of embodiments 45-48, wherein the VTOD further includes a sealing material to contain said electro-optic material, and wherein the sealing material covers at least a portion of the first substrate antenna electrode.

50. The eyewear system according to any of embodiments 45-49, wherein the first substrate antenna electrode includes a metal and is substantially opaque to visible light.

51. The eyewear system according to any of embodiments 45-49, wherein the first transparent electrode and the first substrate antenna electrode include substantially the same conductive material.

52. The eyewear system according to any of embodiments 45-51, wherein the first transparent electrode and the antenna electrode lie in a common plane parallel to a plane defined by a surface of the first substrate.

53. The eyewear system according to any of embodiments 45-52, further including a second substrate antenna electrode provided on the second substrate adjacent to, and separate from, the second transparent electrode, wherein the second substrate antenna electrode serves as another antenna electrode.

54. The eyewear system according to any of embodiments 45-53, wherein the first substrate antenna electrode is characterized by a length of about λ/4, λ/2, or λ(⅝), where λ is the wavelength of the wireless signal to be received or transmitted.

55. The eyewear system of embodiment 44, wherein the first transparent electrode serves as the at least one antenna electrode, and the second transparent electrode serves as the at least one component electrode.

56. The eyewear system according to any of embodiments 44-55, wherein the first voltage profile has a frequency of 1 kHz or less, and the second voltage profile has a frequency of greater than or equal to 200 MHz.

57. The eyewear system according to any of embodiments 44-56, wherein the second voltage profile is applied or sensed concurrently with application of the first voltage profile.

58. The eyewear system according to any of embodiments 44-57, wherein the VTOD driving system and the antenna system each include their own operational microcontroller.

59. The eyewear system according to any of embodiments 44-57, wherein the VTOD driving system and the antenna system share a common operational microcontroller.

60. The eyewear system according to any of embodiments 44-59, wherein the antenna system functions as a monopole antenna, a dipole antenna, a virtual dipole antenna, or a quadrupole antenna.

61. The eyewear system according to any of embodiments 44-60, further including an eyewear system frame to which the VTOD is attached, wherein at least a portion of the VTOD driving system is provided as part of the eyewear system frame.

62. The eyewear system according to any of embodiments 44-61, wherein the VTOD is characterized by a cell gap between the first and second transparent electrodes, wherein the cell gap is in a range of 3 μm to 50 μm.

63. The eyewear system according to any of embodiments 44-62, wherein the electro-optical material includes a liquid crystal host and a dichroic dye guest.

The specific details of particular embodiments may be combined in any suitable manner without departing from the spirit and scope of embodiments of the invention. However, other embodiments of the invention may be directed to specific embodiments relating to each individual aspect, or specific combinations of these individual aspects.

The above description of example embodiments of the invention has been presented for the purposes of illustration and description. It is not intended to be exhaustive or to limit the invention to the precise form described, and many modifications and variations are possible in light of the teaching above.

In the preceding description, for the purposes of explanation, numerous details have been set forth in order to provide an understanding of various embodiments of the present technology. It will be apparent to one skilled in the art, however, that certain embodiments may be practiced without some of these details, or with additional details.

Having described several embodiments, it will be recognized by those of skill in the art that various modifications, alternative constructions, and equivalents may be used without departing from the spirit of the invention. Additionally, a number of well-known processes and elements have not been described in order to avoid unnecessarily obscuring the present invention. Additionally, details of any specific embodiment may not always be present in variations of that embodiment or may be added to other embodiments.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed. The upper and lower limits of these smaller ranges may independently be included or excluded in the range, and each range where either, neither, or both limits are included in the smaller ranges is also encompassed within the invention, subject to any specifically excluded limit in the stated range. Where the stated range includes one or both of the limits, ranges excluding either or both of those included limits are also included.

As used herein and in the appended claims, the singular forms “a”, “an”, and “the” include plural referents unless the context clearly dictates otherwise. Thus, for example, reference to “a method” includes a plurality of such methods and reference to “the layer” includes reference to one or more layers and equivalents thereof known to those skilled in the art, and so forth. The invention has now been described in detail for the purposes of clarity and understanding. However, it will be appreciated that certain changes and modifications may be practiced within the scope of the appended claims.

All publications, patents, and patent applications cited herein are hereby incorporated by reference in their entirety for all purposes. None is admitted to be prior art.

What is claimed is:

1. An eyewear system comprising:
a) a variable transmission optical device (“VTOD”) comprising:
a first transparent electrode provided over a first substrate;
a second transparent electrode provided over a second substrate; and
an electro-optic material comprising a liquid crystal provided between the substrates, wherein each transparent electrode is interposed between its respective substrate and the electro-optic material;
b) a VTOD driving system in electrical communication with the first and second transparent electrodes, the VTOD driving system configured to apply a first voltage profile across the transparent electrodes for controlling an amount of light transmitted through the VTOD; and
c) an antenna system comprising at least one antenna electrode and at least one component electrode, the antenna system configured to apply or sense a second voltage profile to transmit or receive wireless signals,
wherein at least one transparent electrode serves as the at least one antenna electrode or as the at least one component electrode.

2. The eyewear system of claim 1, wherein the at least one antenna electrode is a first substrate antenna electrode provided on the first substrate adjacent to, and separate from, the first transparent electrode.

3. The eyewear system of claim 2, wherein the first transparent electrode serves as the at least one component electrode.

4. The eyewear system of claim 2, wherein the second transparent electrode serves as the at least one component electrode.

5. The eyewear system of claim 2, wherein the second transparent electrode is not oppositely positioned relative to the first substrate antenna electrode in a dimension normal to the first substrate surface.

6. The eyewear system of claim 2, wherein the VTOD further comprises a sealing material to contain said electro-optic material, and wherein the sealing material covers at least a portion of the first substrate antenna electrode.

7. The eyewear system of claim 2, wherein the first substrate antenna electrode comprises a metal and is substantially opaque to visible light.

8. The eyewear system of claim 2, wherein the first transparent electrode and the first substrate antenna electrode comprise substantially the same conductive material.

9. The eyewear system of claim 2, wherein the first transparent electrode and the antenna electrode lie in a common plane parallel to a plane defined by a surface of the first substrate.

10. The eyewear system of claim 2, further comprising a second substrate antenna electrode provided on the second substrate adjacent to, and separate from, the second transparent electrode, wherein the second substrate antenna electrode serves as another antenna electrode.

11. The eyewear system of claim 2, wherein the first substrate antenna electrode is characterized by a length of about λ/4, λ/2, or λ(⅝), where λ is the wavelength of the wireless signal to be received or transmitted.

12. The eyewear system of claim 1, wherein the first transparent electrode serves as the at least one antenna electrode, and the second transparent electrode serves as the at least one component electrode.

13. The eyewear system of claim 1, wherein the first voltage profile has a frequency of 1 kHz or less, and the second voltage profile has a frequency of greater than or equal to 200 MHz.

14. The eyewear system of claim 13, wherein the second voltage profile is applied or sensed concurrently with application of the first voltage profile.

15. The eyewear system of claim 1, wherein the VTOD driving system and the antenna system each comprise their own operational microcontroller.

16. The eyewear system of claim 1, wherein the VTOD driving system and the antenna system share a common operational microcontroller.

17. The eyewear system of claim 1, wherein the antenna system functions as a monopole antenna, a dipole antenna, a virtual dipole antenna, or a quadrupole antenna.

18. The eyewear system of claim 1, further comprising an eyewear system frame to which the VTOD is attached, wherein at least a portion of the VTOD driving system is provided as part of the eyewear system frame.

19. The eyewear system of claim 1, wherein the VTOD is characterized by a cell gap between the first and second transparent electrodes, wherein the cell gap is in a range of 3 μm to 50 μm.

20. The eyewear system of claim 1, wherein the electro-optical material comprises a liquid crystal host and a dichroic dye guest.
